(19) United States
(12) Patent Application Publication
(10) Pub. No.: US 2025/0144735 A1
(43) Pub. Date: May 8, 2025

(54) Method for Plasma Cutting Workpieces

(71) Applicant: Kjellberg-Stiftung, Finsterwalde (DE)

(72) Inventors: André Pötsch, Finsterwalde (DE); Thomas Steudtner, Fürstenwalde (DE); Volker Krink, Finsterwalde (DE); René Nogowski, Dresden (DE)

(73) Assignee: Kjellberg-Stiftung, Finsterwalde (DE)

(21) Appl. No.: 18/684,408

(22) PCT Filed: Aug. 9, 2022
(86) PCT No.: PCT/EP2022/072339

§ 371 Date: Feb. 16, 2024

(30) Foreign Application Priority Data
Aug. 16, 2021 (DE) 102021004182.8
Nov. 8, 2021 (DE) 102021005500.4

(51) Int. Cl. B23K 10/00; B23K 103/04; B23K 103/10

(52) U.S. Cl. CPC B23K 10/003; B23K 2103/05; B23K 2103/10

(57) ABSTRACT

A method for plasma cutting of workpieces, in which use is made of at least one plasma cutting torch having at least one plasma torch body, one electrode and one nozzle, through the nozzle opening of which at least one plasma gas or plasma gas mixture flows and which constricts the plasma jet, wherein, before the plunge cutting of the plasma jet into and through the workpiece, a washout is formed by the workpiece being exposed to the plasma jet from the workpiece surface at least for a duration t2 such that material of the workpiece is removed from the workpiece surface and the washout is produced.

The invention relates to a method for plasma cutting of workpieces, in particular for punch cutting.

Plasma refers to a thermally highly heated, electrically conductive gas, which consists of positive and negative ions, electrons and excited and neutral atoms and molecules.

A variety of gases, for example the monatomic argon or helium and/or the diatomic gases hydrogen, nitrogen, oxygen or air, are used as plasma gas. These gases ionize and dissociate owing to the energy of the plasma arc.

The parameters of the plasma jet can be greatly influenced by the design of the nozzle and electrode. These parameters of the plasma jet are, for example, the jet diameter, the temperature, the energy density and the flow velocity of the gas.

In plasma cutting, for example, the plasma is constricted by means of a nozzle, which may be gas-cooled or water-cooled. For this, the nozzle has a nozzle bore, through which the plasma jet flows. As a result, energy densities to 2×10⁶ W/cm² can be achieved. Temperatures of up to 30 000° C. arise in the plasma jet, which, in combination with the high flow velocity of the gas, produce very high cutting speeds on all electrically conductive materials.

Nowadays, plasma cutting is an established method for cutting electrically conductive materials, with a variety of gases and gas mixtures being used depending on the cutting task.

Plasma torches usually have a plasma torch body, in which an electrode and a nozzle are fastened. Between them flows the plasma gas, which exits through the nozzle bore. The plasma gas is normally guided through a gas guide fitted between the electrode and the nozzle, and can be caused to rotate. Modern plasma torches also have a feeder for a secondary medium, either a gas or a liquid. The nozzle is then surrounded by a secondary gas cap. The nozzle is fixed, in particular in the case of liquid-cooled plasma torches, by a nozzle cap as described, for example, in DE 10 2004 049 445 A1. The cooling medium then flows between the nozzle cap and the nozzle. The secondary medium then flows between the nozzle or the nozzle cap and the secondary gas cap and exits the bore of the secondary gas cap. Said secondary medium influences the plasma jet formed by the arc and the plasma gas. Said secondary medium may be set in rotation by a gas guide which is arranged between the nozzle or the nozzle cap and the secondary gas cap.

The secondary gas cap protects the nozzle and the nozzle cap from the heat or spraying-out molten metal of the workpiece, in particular during the plunge cutting by the plasma jet into the material of the workpiece to be cut. In addition, said secondary gas cap creates a defined atmosphere around the plasma jet during the cutting.

For the plasma cutting of unalloyed and low-alloy steels, also referred to as structural steels, for example S235 and S355 in accordance with DIN EN 10027-1, the plasma gases used are usually air, oxygen or nitrogen or a mixture of these. The secondary gases used are also usually air, oxygen or nitrogen or a mixture of these, with the composition and volume flows of the plasma gas and the secondary gas usually being different, although they can also be the same.

For the plasma cutting of high-alloy steels and stainless steels, for example 1.4301 (X5CrNi10-10) or 1.4541 (X6CrNiTi18-10), the plasma gases used are usually nitrogen, argon, a mixture of argon and hydrogen, a mixture of nitrogen and hydrogen, or a mixture of argon, hydrogen and nitrogen. In principle, the use of air as plasma gas is also possible, but the oxygen fraction in the air leads to oxidation of the cut surfaces and thus to a worse cut quality. The secondary gas used is also usually nitrogen, argon, a mixture of argon and hydrogen, a mixture of nitrogen and hydrogen, or a mixture of argon, hydrogen and nitrogen, with the composition and volume flows of the plasma gas and the secondary gas usually being different, although they can also be the same.

The problem on which the present invention is based is described below.

Here, the advancing speed v is to be understood to mean the speed with which a plasma torch is moved relative and parallel to a workpiece surface. This is generally done by a guide system, for example a CNC controlled coordinate guide machine or a robot.

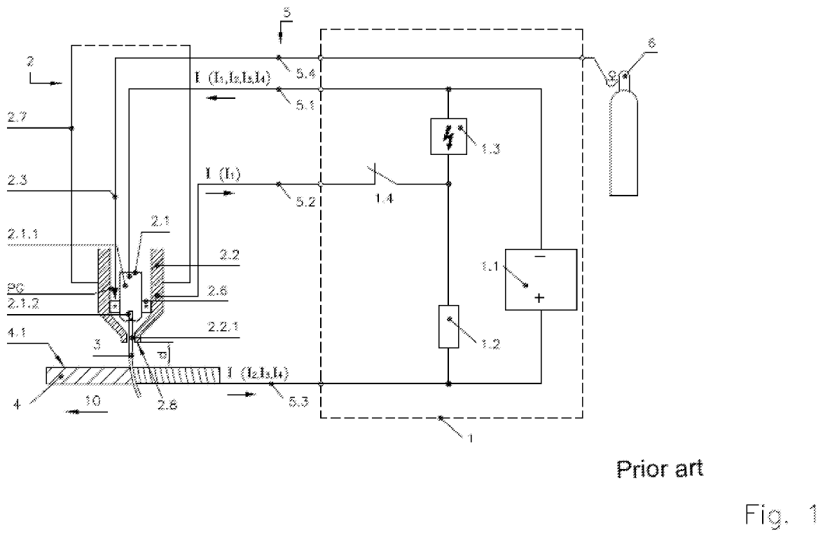

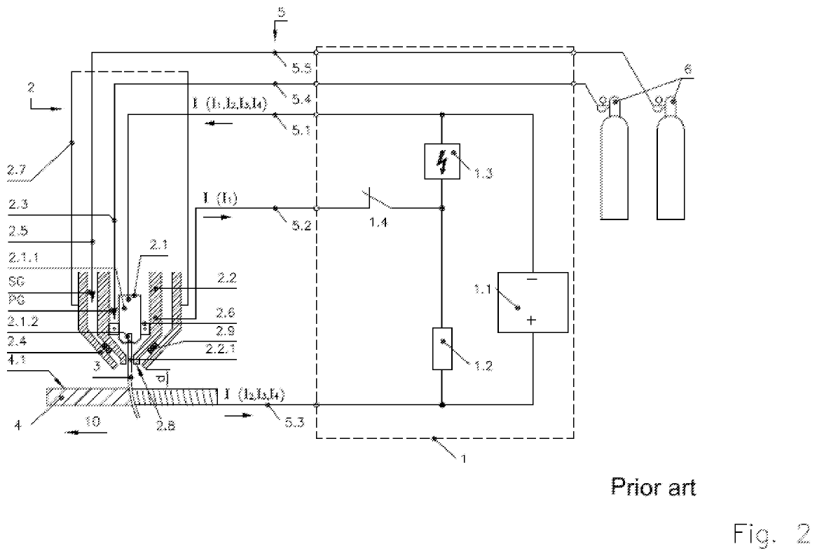

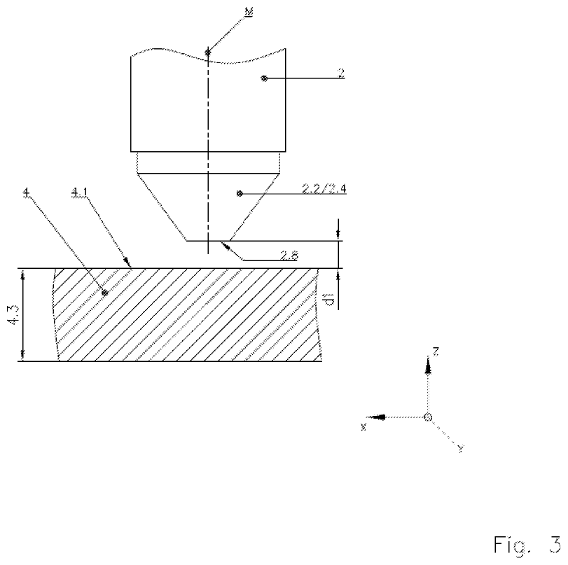

Conventional plasma cutting arrangements are schematically illustrated by way of example in FIGS. 1 and 2. Here, an electrical cutting current flows from a current source 1.1 of a plasma cutting installation 1 via a line 5.1 to a plasma cutting torch 2, via its electrode 2.1 and a plasma jet 3, constricted by a nozzle 2.2 and a nozzle opening 2.2.1, to a workpiece 4, and then back to the current source 1.1 via a line 5.3. The gas supply for the plasma cutting torch 2 is effected via lines 5.4 and 5.5 from a gas supply 6 to the plasma cutting torch 2. The plasma cutting installation 1 contains a high-voltage ignition device 1.3, a pilot resistor 1.2, a current source 1.1 and a switching contact 1.4 and their controller (not shown). Valves for controlling the gases may also be present, but are not illustrated here.

The plasma cutting torch 2 substantially consists of a plasma torch body 2.7 with a jet generating system, comprising the electrode 2.1, the nozzle 2.2 and a gas feeder 2.3 for plasma gas PG. The plasma torch body 2.7 also accommodates the feeder for media (gas, cooling water and electrical current).

The electrode 2.1 of the plasma cutting torch 2 is usually a non-melting electrode 2.1, which consists substantially of a high-temperature material, such as tungsten, zirconium or hafnium, and thus has a very long service life. The electrode 2.1 often consists of two interconnected parts, an electrode holder 2.1.1, which is made of readily electrically and thermally conductive material (for example copper, silver, alloys of these), and a high-melting emission insert 2.1.2 with a low electron work function (such as hafnium, zirconium, tungsten). The nozzle 2.2 usually consists of copper and constricts the plasma jet 3. A gas guide 2.6 for the plasma gas PG, which sets the plasma gas in rotation, may be arranged between the electrode 2.1 and the nozzle 2.2. In this embodiment, that part of the plasma cutting torch 2 from which the plasma jet 3 exits the nozzle 2.2 is referred to as plasma torch tip 2.8. The distance between the plasma torch tip 2.8 and the workpiece surface 4.1 is denoted d.

In FIG. 2, a secondary gas cap 2.4 for feeding a secondary medium, for example a secondary gas SG, is additionally fitted around the nozzle 2.2 of the plasma cutting torch 2. The combination of secondary gas cap 2.4 and secondary gas SG protects the nozzle 2.2 against damage during the plunge cutting of the plasma jet 3 into the workpiece 4 and creates a defined atmosphere around the plasma jet 3. A gas guide 2.9, which can set the secondary gas SG in rotation, is between the nozzle 2.2 and the secondary gas cap 4. In this exemplary embodiment, that point of the plasma cutting torch 2 from which the plasma jet 3 exits the secondary gas cap 2.4 is referred to as plasma torch tip 2.8. The distance between the plasma torch tip 2.8 and the workpiece surface 4.1 is also denoted d.

For the cutting process, firstly a pilot arc, which burns between the electrode 2.1 and the nozzle 2.2, is ignited with a small electrical current (for example 10 A-30 A) and thus low power, for example by means of a high electrical voltage generated by the high-voltage ignition device 1.3. The current (pilot current) of the pilot arc flows through the line 5.1 to the electrode 2.1 and from the nozzle 2.2 through the line 5.2 via the switching contact 1.4 and the electrical resistor 1.2 to the current source 1.1 and is limited by the electrical resistor 1.2. This low-energy pilot arc, by virtue of partial ionization, provides the section between the plasma torch tip 2.8 and the workpiece 4 for the cutting arc. When the pilot arc makes contact with the workpiece 4, the formation of the cutting arc occurs owing to the electrical potential difference between nozzle 2.2 and workpiece 4 generated by the electrical resistor 1.2. This cutting arc then burns between the electrode 2.1 and the workpiece 4 with a usually larger electrical current (for example 20 A to 900 A) and thus also with greater power. The switching contact 1.4 is opened and the nozzle 2.2 is switched from the current source 1.1 in potential-free fashion. This mode of operation is also referred to as direct mode of operation. In the process, the workpiece 4 is subjected to the thermal, kinetic and electrical action of the plasma jet 3. This makes the method very effective and it is possible to cut metals up to high thicknesses, for example 180 mm given a cutting current of 600 A with a cutting speed of 0.2 m/min.

To this end, the plasma cutting torch 2 is moved by means of a guide system (not illustrated) relative to a workpiece 4, or its surface 4.1. Said guide system can, for example, be a robot or a CNC controlled guide machine. The controller of the guide system communicates with the arrangement according to FIG. 1 or 2.

In the simplest case, the controller of the guide system starts and ends the operation of the plasma cutting torch 2. According to the current prior art, however, a multiplicity of signals and information, for example about operating states and dates, apart from just ON and OFF can be exchanged between the controller of the guide system and the plasma cutting installation.

During plasma cutting, high cut qualities can be achieved. Criteria for this are, for example, a low perpendicularity and angularity tolerance in accordance with DIN ISO 9013. Maintaining the optimum cutting parameters, which among other things include the electrical cutting current, the cutting speed, the distance between the plasma cutting torch and the workpiece, and the gas pressure, makes it possible to obtain smooth cut surfaces and burr-free edges.

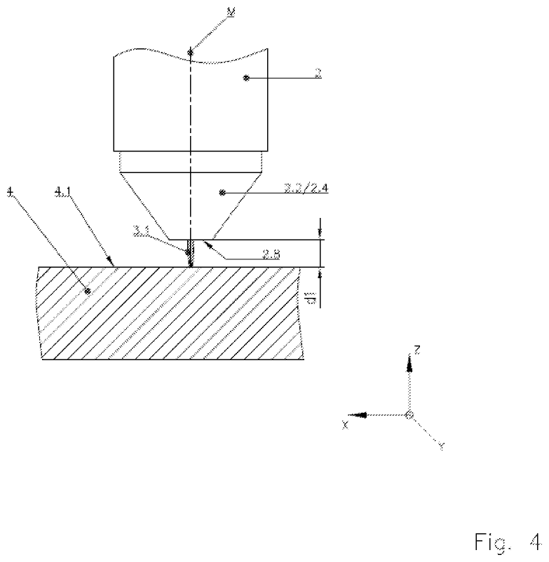

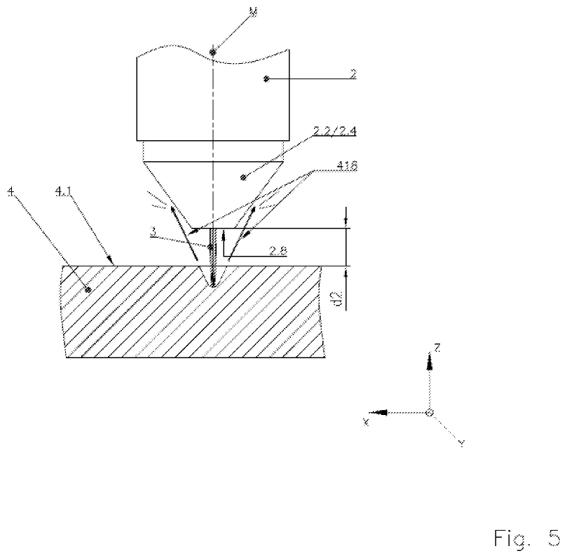

A typical cutting task for plasma cutting is cutting out one or more contours from a workpiece. For this, it is necessary to make a plunge cut into the workpiece 4 and puncture it through before the contour is cut. To this end, the plasma cutting torch 2 is positioned, as shown by way of example in FIG. 3, with a distance d1 between the torch tip 2.8 and the workpiece surface 4.1 and the pilot arc 3.1, as shown by way of example in FIG. 4, is ignited. Usually, d1 must be selected such that the pilot arc reaches the workpiece surface and the arc can “move” from the nozzle to the workpiece and the plasma jet can form towards the workpiece.

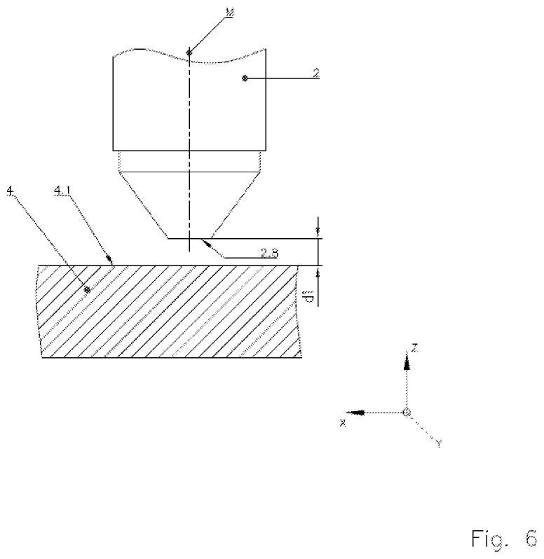

In the case of plunge cutting, shown by way of example in FIG. 5, into and through the workpiece 4, by contrast to starting at the workpiece edge, the entire workpiece thickness 4.3 must be “punctured through”. In the process, the material 418 melted owing to the action of the plasma jet 3 sprays upwards in the direction of the plasma cutting torch 2, in particular against the nozzle 2.2 or the secondary gas cap 2.4 and the plasma torch tip 2.8, and can damage them. The prior art attempts to keep the upwardly spraying material 418, melted during the plunge cutting, away from the nozzle 2.2, the secondary gas cap 2.4 and the plasma torch tip 2.8 and from the plasma torch 2 by way of a greater plasma torch distance d2. The greater plasma torch distance d2 causes some of the molten material 418 of the workpiece 4 to spray past the nozzle 2.2, the secondary gas cap 2.4 and the plasma torch tip 2.8, or the plasma cutting torch 2. However, some of the upwardly spraying material remains, and this material in particular in the case of greater sheet thicknesses is sprayed against the aforementioned components and damages them. It is also sought to guide the plasma cutting torch 2 parallel to the workpiece surface 4.1, in the direction of the contour to be cut out, with a lower speed than the cutting speed, in order to keep the upwardly spraying material away from the plasma cutting torch and the aforementioned components.

After the workpiece 4 has been punctured through, the molten material sprays out of the workpiece bottom side 4.5 and the workpiece can be cut.

In the case of plasma cutting with a cutting current of 300 A, it is thus usually possible to cut a maximum workpiece thickness of 80 mm and plunge cut into a maximum workpiece thickness of 50 mm.

In the process, already from a workpiece thickness 4.3 of 40 mm, upwardly spraying material 418 of the melted workpiece 4 makes contact with the plasma torch tip 2.8, the nozzle 2.2 and the nozzle tip or the secondary gas cap 2.4 and the secondary gas cap tip and damages them owing to its high temperature. After that, it is often no longer possible to cut a good-quality component out of the workpiece since the nozzle opening 2.2.1, forming the cutting arc or the plasma jet 3, and/or the secondary gas cap bore are/is damaged and no longer round. What can even occur is that the nozzle 2.2 or the secondary gas cap 2.4 is downright destroyed when a parasitic so-called secondary arc, which burns from the electrode to the nozzle and/or secondary gas cap and to the workpiece, forms.

In the case of plunge cutting into even thicker material, the nozzle and/or the secondary gas cap, and often even the plasma torch, are almost certain to be damaged.

The present invention is therefore based on the object of avoiding, but at least reducing, damage to a plasma torch, a plasma torch tip, in particular a nozzle, a nozzle opening and/or a secondary gas cap during plunge cutting into a workpiece owing to upwardly spraying, molten hot material, in order to in particular also be able to plunge cut more reliably even into greater sheet thicknesses.

The invention achieves this object by a method according to claim 1. The washout can also be referred to as recess or depression.

The dependent claims relate to advantageous refinements of the method.

The present invention is based on the surprising finding that it is possible to perform plunge cutting into and through thicker material in comparison with the prior art by virtue of the production of a washout on a workpiece surface prior to plunge cutting into and through the workpiece, for example by virtue of parameters with which the plasma cutting torch is operated or moved that differ from the cutting.

Further features and advantages of the invention emerge from the appended claims and the following description, in which several exemplary embodiments are explained with reference to the schematic drawings, in which:

FIG. 1 shows a plasma cutting arrangement according to the prior art;

FIG. 2 shows another plasma cutting arrangement according to the prior art;

FIG. 3 shows the operation for positioning a plasma cutting torch during the plasma cutting, by way of example;

FIG. 4 shows the operation for igniting a pilot arc in the course of the plasma cutting, by way of example;

FIG. 5 shows the plunge cutting operation of a plasma jet during the plasma cutting, by way of example;

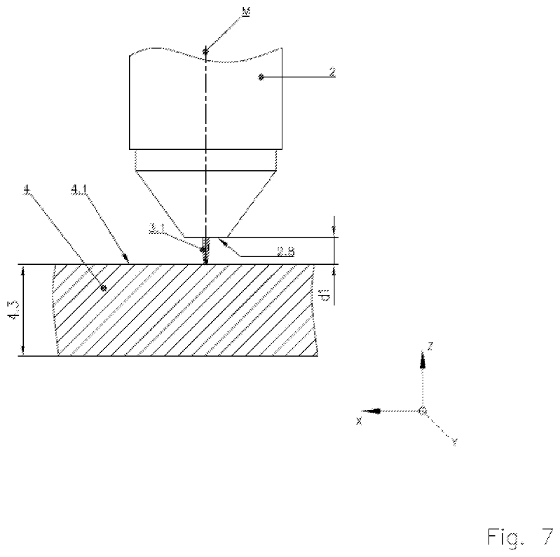

FIGS. 6 to 13 show details of a method for plasma cutting of workpieces according to a particular embodiment of the present invention;

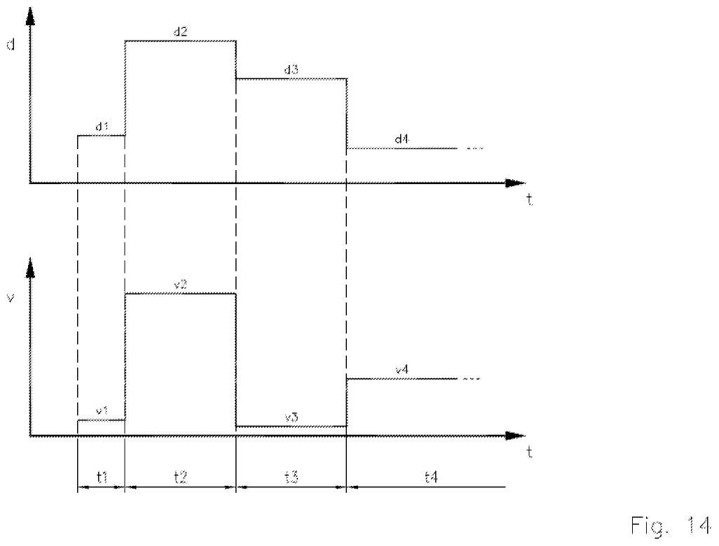

FIG. 14 shows changes in the plasma torch distance and advancing speed over time according to a particular embodiment of the present invention; and

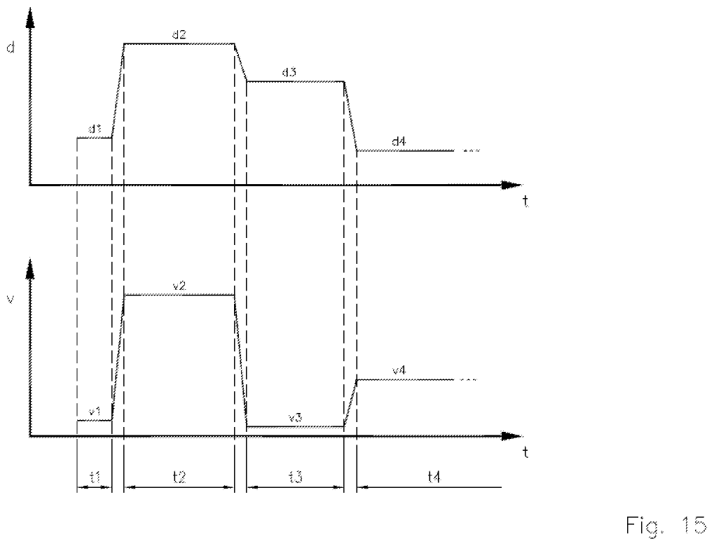

FIG. 15 shows changes in the plasma torch distance and advancing speed over time according to another particular embodiment of the present invention.

To this end, the plunge cutting process through to the final plunge cutting into and through the workpiece will be explained by way of example for structural steel with a material thickness 4.3 of, for example, 60 mm and a cutting current I4 of, for example, 300 A. During the cutting, the advancing speed v4 of the plasma cutting torch 2 is, for example, 300 mm/min and the plasma torch distance d4 is, for example, 7 mm. The plasma gas PG used for the cutting is, for example, oxygen and the secondary gas SG used for the cutting is, for example, air. The kerf width 452 of the kerf 450 produced during the cutting is approximately 6.5 mm.

In this respect, the plunge cutting process can be subdivided here by way of example essentially into 4 phases.
Phase 1: Positioning the plasma torch, igniting the pilot arc, and introducing the main arc
Phase 2: Washing out the workpiece from the workpiece surface
Phase 3: Plunge cutting into and through the workpiece
Phase 4: Cutting

The phases can transition directly into one another and even partially overlap. However, transition operations between the phases and in principle also further and/or alternative phases are also possible.

FIG. 6 shows, by way of example, how a plasma torch 2 with a plasma torch distance d1 of, for example, 9 mm is positioned between a plasma torch tip 2.8 and a workpiece surface 4.1 (phase 1). Usually, d1 must be selected such that the pilot arc reaches the workpiece surface and the arc “moves” from the nozzle to the workpiece, and the plasma jet can form towards the workpiece.

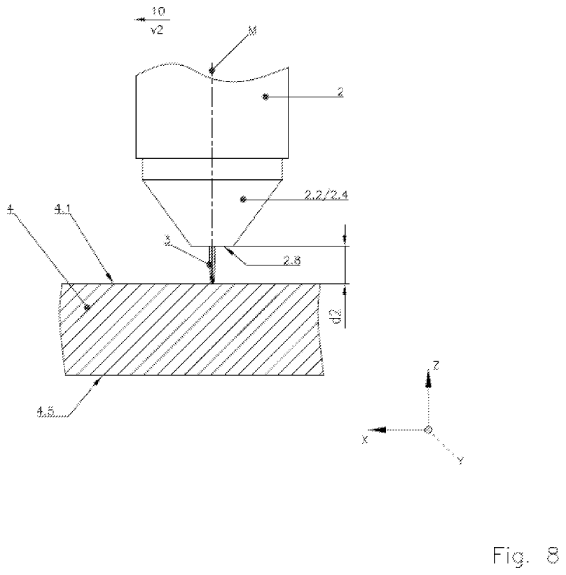

FIG. 7 shows that a pilot arc 3.1 has been ignited. It burns initially between an electrode 2.1 and a nozzle 2.2 (not illustrated here; see FIGS. 1 and 2) with, for example, 25 A (phase 1).

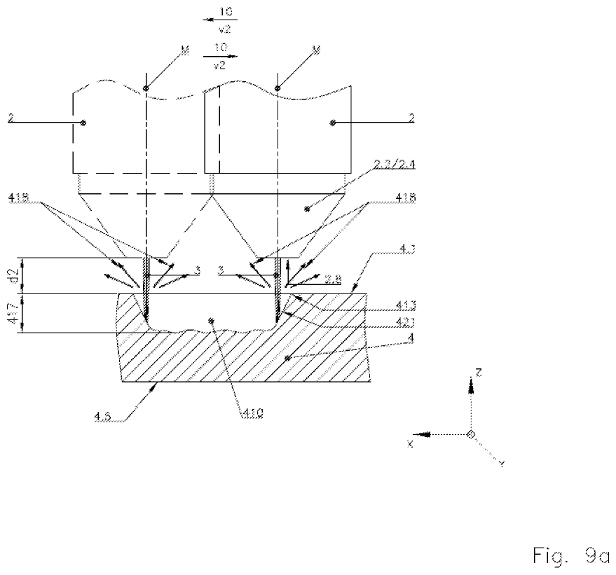

The anodic point of contact moves from the nozzle 2.2 to the workpiece 4 after the pilot arc 3.1 is ignited, a plasma jet 3 forms and the plasma torch distance d is increased from d1 to d2=25 mm, as illustrated in FIG. 8 (phase 2).

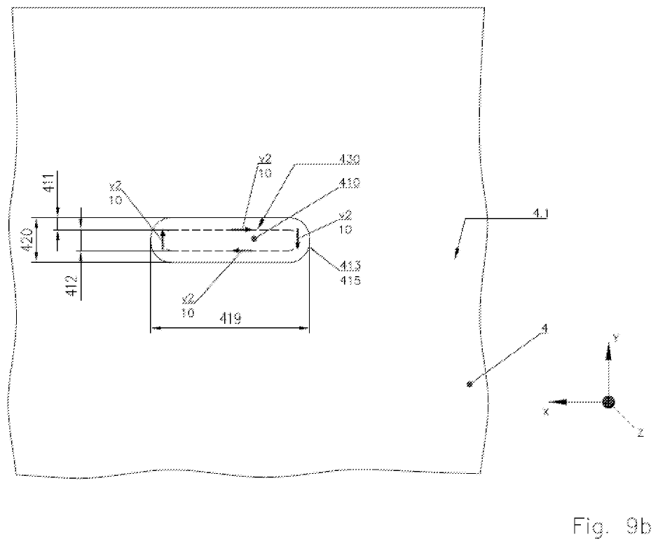

The current is increased to the cutting current of, for example, 300 A. The advancing speed v, with which the plasma cutting torch 2 is moved with respect to the workpiece surface 4.1 in the advancing direction 10, is increased from v1, of for example 0 mm/min, to v2, of for example 2800 mm/min. It is advantageously considerably greater than the advancing speed v4 during the cutting (phase 4). The shape of the contour 430 described by the plasma torch 2 with respect to the workpiece surface 4.1, as seen from above onto the workpiece surface 4.1, with the advancing speed v2 is in this case an oval contour 430 with a size of, for example, approximately 48 mm×8 mm (FIG. 9b). The advancing speed v2 and the plasma torch distance d2 are large enough that the molten material 418 spraying upwards from the workpiece surface 4.1 is sprayed away to the side such that it does not make contact with the plasma cutting torch 2, the nozzle 2.2, a secondary gas cap 2.4 and the plasma torch tip 2.8, or makes contact with them only to a small enough extent that they are not damaged, as shown in FIG. 9a (phase 2). This is achieved in this example in particular by the combination of the described parameters v2 and d2. It is only the case that material is removed. In the process, the plasma cutting torch is advantageously moved fast enough (v2) and is far enough away (d2) that the molten material is sprayed away to the side. It is also possible to conceive that the fast movement deflects the plasma jet counter to the advancing direction. The molten material then also sprays in this direction.

Overall, it would also be possible to say that advantageously the input of energy into the surface per unit length (mm) is less than during the cutting.

FIG. 9b shows a plan view of the workpiece surface 4.1 of the oval contour 430 described by the plasma cutting torch 2. The oval contour is traversed twice here by way of example and the likewise shown one washout 410 with a length 419 of, for example, approximately 57 mm and a width 420 of, for example, 17 mm is produced. The washout 410 has an oval shape 415 with a peripheral edge 413 at the transition between the washout 410 and the workpiece surface 4.1. The distance 417 of the deepest point of the washout 410, measured perpendicularly (i.e. in the z direction according to the Cartesian coordinate system depicted in the figures) in relation to the workpiece surface 4.1, is for example 25 mm here (phase 2).

The smallest distance 411 between the edge 413 of the resulting washout 410 and the oval contour 430 described by the plasma cutting torch 2 is, for example, approximately 4.5 mm, the distance 412 between the longitudinal edges of the oval contour 430 described by the plasma cutting torch 2 is, for example, 8 mm. Therefore, in this example, the distance 411 is less than the distance 412 and the distance 412 is less than twice the distance 411.

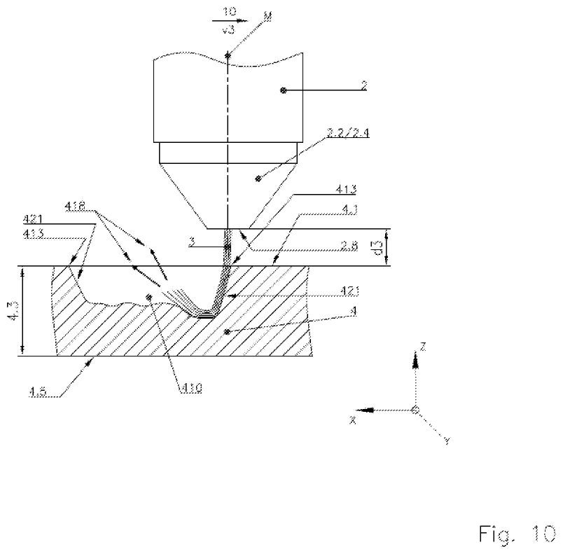

FIG. 10 shows the plasma cutting torch 2 shortly after it stops traversing the contour 430. It has been moved for example, approximately 2 mm in the direction of the edge 413 of the washout 410 and positioned such that the plasma jet 3 at least partially strikes the edge 413 and/or the slope 421 of the washout 410.

Thus, the hot material 418, which now sprays upwards during the plunge cutting, as shown in FIG. 10, into and through the workpiece 4 primarily sprays away to the side in the direction of the washout 410 such that it does not make contact with the plasma cutting torch 2 and its constituent parts: the nozzle 2.2, the torch tip 2.8 and the secondary gas cap 2.4, or makes contact with them only to a very small enough extent. During the plunge cutting (phase 3), shown in FIG. 10, into and through the workpiece 4 the advancing speed v of the plasma cutting torch 2 can be v3=0 m/min or between 0 and advancing speed v4, with which the workpiece 4 is cut. The advancing speed v3 is advantageously considerably less than the advancing speed v2 during the material removal. The length 419 of the washout 410 is large enough that the material 418 spraying upwards during the puncturing-through can spray away counter to the cutting direction 10 through the washout 410 such that it does not make contact, or most of it does not make contact, with the plasma cutting torch 2, the plasma torch tip 2.8, the nozzle 2.2 and/or the secondary gas cap 2.4. In other words, the washout 410 should advantageously be large enough that the molten material 418 spraying upwards to the side owing to the high advancing speed v2 can “fly through” between the plasma cutting torch 2 and its constituent parts (nozzle 2.2, secondary gas cap 2.4, plasma torch tip 2.8) and the edge 413 and the slope 421 of the washout 410. If the washout is too small, the upwardly spraying material strikes the opposite part of the edge 413 and the slope 421 of the washout 410 and can be deflected, or turned back, towards the plasma cutting torch 2.

In the example, the advancing speed v3=0 m/min. In phase 3, the plasma torch distance d3, at 25 mm, is selected to be the same as the plasma torch distance d2 during the material removal. The plasma torch distance d3 is greater than the plasma torch distance d4 during the cutting (phase 4).

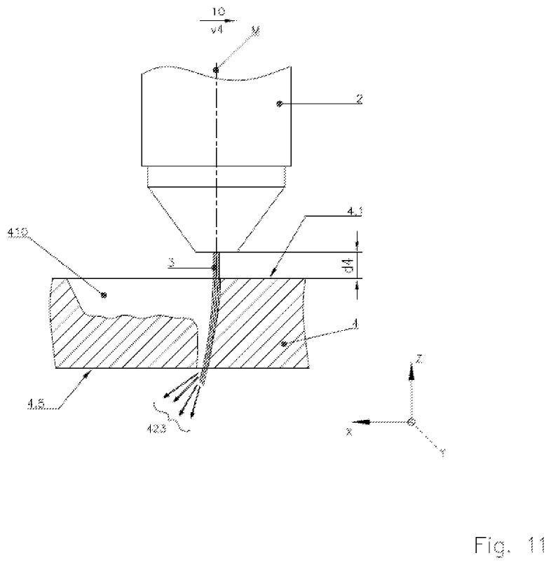

After the workpiece 4 has been punctured through, as shown in FIGS. 11, 12 and 13, the advancing speed v4 selected for the cutting of, for example, 60 mm of structural steel and the plasma torch distance d4 can be set in order to carry out the cutting process, in which a kerf 450 with a kerf width 452 is produced (phase 4).

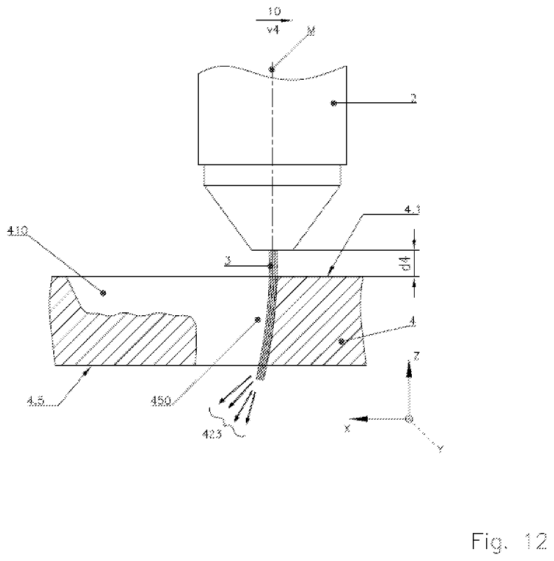

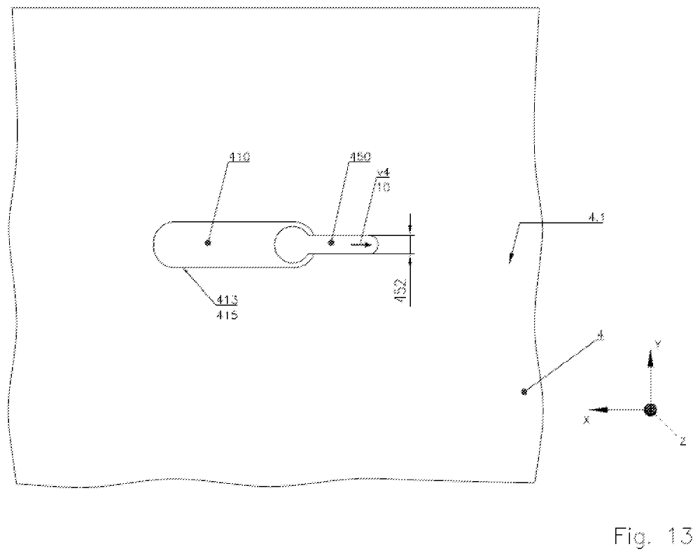

In this respect, FIG. 11 shows the plasma cutting torch 2 directly after puncturing through the workpiece, FIG. 12 shows the plasma cutting torch during the cutting and FIG. 13 shows the plan view of the workpiece surface 4.1 and the kerf 450 and washout 410 created by the plasma cutting torch 2 (illustration without the plasma cutting torch 2). Here, the molten material 423 sprays out of the workpiece bottom side 4.5.

FIGS. 14 and 15 show, by way of example, the schematic development of the plasma torch distance (d, d1, d2, d3, d4) and the advancing speed (v, v1, v2, v3, v4) of the plasma cutting torch 2 during the temporal phases 1, 2, 3 and 4. FIG. 15 additionally shows that at least one further phase may be present between the phases 1, 2, 3 and 4. This can also be just the transition between two parameters, for example v1 and v2, v2 and v3, v3 and v4 and/or d1 and d2, d2 and d3, d3 and d4. In practice, this is usually the case, because then the “abrupt” transitions shown in FIG. 14 are not there. It is, however, also possible for additional longer phases to be intentionally present.

For example, in particular between phase 3 and phase 4, there may be a further phase 5 with a time t5, during which the plasma torch distance d5 and/or the advancing speed v5 differ(s) from that/those of phases 3 and 4.

This is particularly expedient if a portion of molten material is located on the workpiece surface, in which case it holds true that:

$$v 3 < v 5 < v 4 and / or$$

$$d 3 <= d 5 > d 4$$

There is also the option of inserting pauses between the phases or at least two phases, for example to allow the workpiece 4 or the plasma cutting torch 2 to cool down or to remove spatter of the molten workpiece 4 on the workpiece surface 4.1. During pauses, the current I can, for example, be “0”.

In each phase, the vector of the advancing speed can in principle, in addition to a component which is parallel to the workpiece surface, i.e. in the x-y plane in the Cartesian coordinate system depicted in the figures, of which the y axis extends (perpendicularly) into the plane of the drawing, also have a component (z component) perpendicular to the workpiece surface. This would then bring about the modification of the parameter d.

In examples, d is modified at least in the transitions between the phases. This results in the perpendicular component of v.

In the example described, for the material removal or the production of the washout 410 (phase 2), a higher advancing speed v2 than the advancing speed v4 during the cutting and a higher plasma torch distance d2 than the plasma torch distance d4 during the cutting (phase 4) were selected. The current I2 here advantageously has the same magnitude as the cutting current I4 during the cutting.

However, other combinations of the parameters, for example according to claims 3 to 9, are also possible. In this case, first and foremost it is essential to combine them such that the molten material 418 spraying upwards from the workpiece surface 4.1 sprays away to the side such that it does not make contact with the plasma torch 2, in particular its nozzle 2.2 or its secondary gas cap or its plasma torch tip 2.8, or makes contact with them only to a small enough extent, and thus does not damage them.

It is thus possible, for example, during phase 2 of removing material and washing out, to work with the following parameters that are modified in comparison with the cutting (phase 4):
With a higher advancing speed v2 than v4 and/or
with a lower current I2 than I4 and/or
with a greater plasma torch distance d2 than d4 and/or
with a lower pressure p12 of the plasma gas PG than p14 and/or
with a lower volume and/or mass flow m12 of the plasma gas than m14 and/or
with a lower pressure p22 of the secondary gas SG than p24 and/or
with a lower volume and/or mass flow m12 of the secondary gas than m24 and/or
with a composition of the plasma gas or plasma gas mixture which comprises a lower oxidizing fraction during phase 2, and/or
with a composition of the plasma gas or plasma gas mixture which comprises a lower reducing fraction during phase 2, and/or
with a composition of the secondary gas or secondary gas mixture which comprises a lower oxidizing fraction during phase 2, and/or
with a composition of the secondary gas or secondary gas mixture which comprises a lower reducing fraction during phase 2.

In this respect, different combinations of the parameters are also possible.

For a particularly easy implementation, it is expedient to modify the material removal or washing out not in terms of all of the listed parameters that are modified in comparison with the cutting, but as far as possible to use only three, better only two modified parameters.

The following combinations should be mentioned by way of example for the sake of better understanding:
With a higher advancing speed v2 than v4 and a greater plasma torch distance d2 than d4.
With a higher advancing speed v2 than v4 and a lower pressure p12 of the plasma gas PG than p14.
With a higher advancing speed v2 than v4 and a lower volume and/or mass flow m12 of the plasma gas than m14.
With a higher advancing speed v2 than v4 and a lower pressure p22 of the secondary gas SG than p24.
With a higher advancing speed v2 than v4 and a lower volume and/or mass flow m12 of the secondary gas than m24.
With a higher advancing speed v2 than v4 and a composition of the plasma gas or plasma gas mixture which comprises a lower reducing fraction.
With a higher advancing speed v2 than v4 and a composition of the plasma gas or plasma gas mixture which comprises a lower reducing fraction.
With a higher advancing speed v2 than v4 and a composition of the secondary gas or secondary gas mixture which comprises a lower oxidizing fraction.
With a higher advancing speed v2 than v4 and a composition of the secondary gas or secondary gas mixture which comprises a lower reducing fraction.
With a greater plasma torch distance d2 than d4 and a lower pressure p12 of the plasma gas PG than p14.
With a greater plasma torch distance d2 than d4 and a lower volume and/or mass flow m12 of the plasma gas than m14.
With a greater plasma torch distance d2 than d4 and a lower pressure p22 of the secondary gas SG than p24.
With a greater plasma torch distance d2 than d4 and a lower volume and/or mass flow m12 of the secondary gas than m24.
With a greater plasma torch distance d2 than d4 and a composition of the plasma gas or plasma gas mixture which comprises a lower oxidizing fraction during phase 2.
With a greater plasma torch distance d2 than d4 and a composition of the plasma gas or plasma gas mixture which comprises a lower reducing fraction during phase 2.
With a greater plasma torch distance d2 than d4 and a composition of the secondary gas or secondary gas mixture which comprises a lower oxidizing fraction during phase 2.
With a greater plasma torch distance d2 than d4 and a composition of the secondary gas or secondary gas mixture which comprises a lower reducing fraction during phase 2.

However, other combinations are also possible.

Oxidizing fraction is understood to mean the fraction, in percent by volume, of oxidizing gas, for example oxygen or carbon dioxide, in the plasma gas or secondary gas. Reducing fraction is understood to mean the fraction, in percent by volume, of reducing gas, for example hydrogen or methane, in the plasma gas or secondary gas.

The following advantageous parameters are indicated by way of example. The following table establishes the relationship between the parameters and the corresponding reference signs.

| Parameter | Unit | Phase 1 | Phase 2 | Phase 3 | Phase 4 |
|---|---|---|---|---|---|
| Plasma torch | mm | d1 | d2 | d3 | d4 |
| distance d | | | | | |
| Advancing | mm/min | v1 | v2 | v3 | v4 |
| speed v | | | | | |
| Current | A | I1 | I2 | I3 | I4 |
| Time t | ms | t1 | t2 | t3 | Cutting |
| | | | | | time (1) |
| Plasma gas | bar | p11 | p12 | p13 | p14 |
| pressure p1 | | | | | |
| Secondary gas | bar | p21 | p22 | p23 | p24 |
| pressure p2 | | | | | |

(1) This time depends on the size of the component that is to be cut out.

### EXAMPLE 1

Material: low-alloy steel (structural steel) S235
Material thickness: 40 mm
Cutting speed v4: 500 mm/min
Cutting current I4: 150 A
Plasma gas: Oxygen
Secondary gas: Air
Shape and size (length×width) of the contour 430 with which the plasma cutting torch 2 is moved for the washing out in phase 2: Oval, 35 mm×6 mm, traversed 2 times Shape and size (max. length 419×width 420) of the resulting washout 410: Oval, approx. 43 mm×14 mm

| Parameter | Unit | Phase 1 | Phase 2 | Phase 3 | Phase 4 |
|---|---|---|---|---|---|
| Plasma torch | mm | 6 | 20 | 12 | 5 |
| distance d | | | | | |
| Advancing | mm/min | 0 | 2800 | 0 | 300 |
| speed v | | | | | |
| Current I | A | 0 . . . 150 | 150 | 150 | 150 |
| Time t | ms | 500 | 3500 | 5000 | Cutting |
| | | | | | time |
| Plasma gas | bar | 8.0 | 8.0 | 8.0 | 8.0 |
| pressure p1 | | | | | |
| Secondary gas | bar | 4.0 | 4.0 | 4.0 | 4.0 |
| pressure p2 | | | | | |

### EXAMPLE 2

Material: low-alloy steel (structural steel) S235
Material thickness: 60 mm
Cutting speed v4: 300 mm/min
Cutting current I4: 300 A
Plasma gas: Oxygen
Secondary gas: Air
Shape and size (length×width) of the contour 430 with which the plasma cutting torch 2 is moved for the washing out in phase 2: Oval, 48 mm×8 mm, traversed 2 times Shape and size (max. length 419×width 420) of the resulting washout 410: Oval, approx. 57 mm×17 mm

| Parameter | Unit | Phase 1 | Phase 2 | Phase 3 | Phase 4 |
|---|---|---|---|---|---|
| Plasma torch | mm | 9 | 25 | 25 | 7 |
| distance d | | | | | |
| Advancing | mm/min | 0 | 2800 | 0 | 300 |
| speed v | | | | | |
| Current I | A | 0 . . . 300 | 300 | 300 | 300 |
| Time t | ms | 500 | 4500 | 10 000 | Cutting |
| | | | | | time |
| Plasma gas | bar | 6.5 | 6.5 | 6.5 | 6.5 |
| pressure p1 | | | | | |
| Secondary gas | bar | 3.5 | 3.5 | 3.5 | 3.5 |
| pressure p2 | | | | | |

### EXAMPLE 3

Material: low-alloy steel (structural steel) S235
Material thickness: 70 mm
Cutting speed v4: 170 mm/min
Cutting current I4: 300 A
Plasma gas: Oxygen
Secondary gas: Air
Shape and size (length×width) of the contour 430 with which the plasma cutting torch 2 is moved for the washing out in phase 2: Oval, 48 mm×8 mm, traversed 2 times Shape and size (max. length 419×width 420) of the resulting washout 410: Oval, approx. 57 mm×17 mm

| Parameter | Unit | Phase 1 | Phase 2 | Phase 3 | Phase 4 |
|---|---|---|---|---|---|
| Plasma torch | mm | 9 | 30 | 20 | 9 |
| distance d | | | | | |
| Advancing | mm/min | 0 | 2800 | 0 | 170 |
| speed v | | | | | |
| Current I | A | 0 . . . 300 | 300 | 300 | 300 |
| Time t | ms | 500 | 4800 | 5000 | Cutting |
| | | | | | time |
| Plasma gas | bar | 6.5 | 6.5 | 6.5 | 6.5 |
| pressure p1 | | | | | |
| Secondary gas | bar | 2.5 | 2.5 | 2.5 | 2.5 |
| pressure p2 | | | | | |

### EXAMPLE 4

Material: high-alloy steel (stainless steel) 1.4301
Material thickness: 40 mm
Cutting speed v4: 250 mm/min
Cutting current I4: 150 A
Plasma gas: Mixture of argon and hydrogen
Secondary gas: Nitrogen
Shape and size (length×width) of the contour 430 with which the plasma cutting torch 2 is moved for the washing out in phase 2: Oval, 40 mm×6 mm, traversed 2 times Shape and size (max. length 419×width 420) of the resulting washout 410: Oval, approx. 45 mm×11 mm

| Parameter | Unit | Phase 1 | Phase 2 | Phase 3 | Phase 4 |
|---|---|---|---|---|---|
| Plasma torch | mm | 8 | 20 | 12 | 5 |
| distance d | | | | | |
| Advancing | mm/min | 0 | 2800 | 0 | 250 |
| speed v | | | | | |
| Current I | A | 0 . . . 150 | 150 | 150 | 150 |
| Time t | ms | 500 | 3000 | 5000 | Cutting |
| | | | | | time |
| Plasma gas | bar | 6.5 | 6.5 | 6.5 | 6.5 |
| pressure p1 | | | | | |
| Secondary gas | bar | 2.0 | 2.0 | 2.0 | 2.0 |
| pressure p2 | | | | | |

### EXAMPLE 5

Material: high-alloy steel (stainless steel) 1.4301
Material thickness: 50 mm
Cutting current I4: 150 A
Cutting speed v4: 170 mm/min
Plasma gas: Mixture of argon and hydrogen
Secondary gas: Nitrogen
Shape and size (length×width) of the contour 430 with which the plasma cutting torch 2 is moved for the washing out in phase 2: Oval, 60 mm×6 mm, traversed 3 times Shape and size (max. length 419×width 420) of the resulting washout 410: Oval, approx. 65 mm×11 mm

| Parameter | Unit | Phase 1 | Phase 2 | Phase 3 | Phase 4 |
|---|---|---|---|---|---|
| Plasma torch | mm | 8 | 20 | 12 | 5 |
| distance d | | | | | |
| Advancing | mm/min | 0 | 2800 | 0 | 170 |
| speed v | | | | | |
| Current I | A | 0 . . . 150 | 150 | 150 | 150 |
| Time t | ms | 500 | 8500 | 8500 | Cutting |
| | | | | | time |
| Plasma gas | bar | 6.5 | 6.5 | 6.5 | 6.5 |
| pressure p1 | | | | | |
| Secondary gas | bar | 2.0 | 2.0 | 2.0 | 2.0 |
| pressure p2 | | | | | |

### EXAMPLE 6

Material: high-alloy steel (stainless steel) 1.4301
Material thickness: 60 mm
Cutting current I4: 300 A
Cutting speed v4: 410 mm/min
Plasma gas: Mixture of argon and hydrogen
Secondary gas: Nitrogen
Shape and size (length×width) of the contour 430 with which the plasma cutting torch 2 is moved for the washing out in phase 2: Oval, 40 mm×6 mm, traversed 1 time Shape and size (max. length 419×width 420) of the resulting washout 410: Oval, approx. 50 mm×15 mm

| Parameter | Unit | Phase 1 | Phase 2 | Phase 3 | Phase 4 |
|---|---|---|---|---|---|
| Plasma torch | mm | 9 | 30 | 20 | 7 |
| distance d | | | | | |
| Advancing | mm/min | 0 | 2800 | 0 | 410 |
| speed v | | | | | |
| Current I | A | 0 . . . 300 | 300 | 300 | 300 |
| Time t | ms | 500 | 2000 | 5000 | Cutting |
| | | | | | time |
| Plasma gas | bar | 6.5 | 6.5 | 6.5 | 6.5 |
| pressure p1 | | | | | |
| Secondary gas | bar | 5.0 | 5.0 | 5.0 | 5.0 |
| pressure p2 | | | | | |

### EXAMPLE 7

Material: Aluminium AlMg3
Material thickness: 50 mm
Cutting current I4: 150 A
Cutting speed v4: 300 mm/min
Plasma gas: Mixture of argon and hydrogen
Secondary gas: Nitrogen
Shape and size (length×width) of the contour 430 with which the plasma cutting torch 2 is moved for the washing out in phase 2: Oval, 60 mm×6 mm, traversed 1 time Shape and size (max. length 419×width 420) of the resulting washout 410: Oval, approx. 62 mm×8 mm

| Parameter | Unit | Phase 1 | Phase 2 | Phase 3 | Phase 4 |
|---|---|---|---|---|---|
| Plasma torch | mm | 8 | 20 | 15 | 3 |
| distance d | | | | | |
| Advancing | mm/min | 0 | 2800 | 0 | 300 |
| speed v | | | | | |
| Current I | A | 0 . . . 150 | 150 | 150 | 150 |
| Time t | ms | 500 | 2900 | 5000 | Cutting |
| | | | | | time |
| Plasma gas | bar | 8.0 | 8.0 | 8.0 | 8.0 |
| pressure p1 | | | | | |
| Secondary gas | bar | 7.5 | 7.5 | 7.5 | 7.5 |
| pressure p2 | | | | | |

### EXAMPLE 8

Material: Aluminium AlMg3
Material thickness: 60 mm
Cutting current I4: 300 A
Cutting speed v4: 700 mm/min
Plasma gas: Mixture of argon and hydrogen
Secondary gas: Nitrogen
Shape and size (length×width) of the contour 430 with which the plasma cutting torch 2 is moved for the washing out in phase 2: Oval, 60 mm×8 mm, traversed 1 time Shape and size (length 419×width 420) of the resulting washout 410: Oval, approx. 66 mm×14 mm

| Parameter | Unit | Phase 1 | Phase 2 | Phase 3 | Phase 4 |
|---|---|---|---|---|---|
| Plasma torch | mm | 9 | 30 | 20 | 5 |
| distance d | | | | | |
| Advancing | mm/min | 0 | 2800 | 0 | 700 |
| speed v | | | | | |
| Current I | A | 0 . . . 300 | 300 | 300 | 300 |
| Time t | ms | 500 | 2800 | 1000 | Cutting |
| | | | | | time |
| Plasma gas | bar | 8.0 | 8.0 | 8.0 | 8.0 |
| pressure p1 | | | | | |
| Secondary gas | bar | 7.5 | 7.5 | 7.5 | 7.5 |
| pressure p2 | | | | | |

The features of the invention that are disclosed in the above description, in the drawings and in the claims can be essential both individually and in any desired combinations for the implementation of the invention in its various embodiments.

### LIST OF REFERENCE SIGNS

1 Plasma cutting installation
1.1 Current source
1.2 Pilot resistor
1.3 High-voltage ignition device
1.4 Switching contact
2 Plasma cutting torch
2.1 Electrode
2.1.1 Electrode holder
2.1.2 Emission insert
2.2 Nozzle
2.2.1 Nozzle opening
2.3 Gas feeder for plasma gas
2.4 Secondary gas cap
2.5 Secondary gas feeder for secondary gas
2.6 Gas guide for plasma gas
2.7 Plasma torch body
2.8 Plasma torch tip
2.9 Gas guide for secondary gas
3 Plasma jet
3.1 Pilot arc
4 Workpiece
4.1 Workpiece surface
4.3 Workpiece thickness
4.5 Workpiece bottom side
5 Feeders
5.1 Line for cutting current
5.2 Line for pilot current
5.3 Line between workpiece and plasma cutting installation
5.4 Line for plasma gas
5.5 Line for secondary gas 1
6 Gas supply
10 Advancing direction of the plasma cutting torch
410 Washout
411 Distance between contour 430 and edge 413 of the washout 410
412 Distance between the longitudinal edges of the contour 430
413 Edge of the washout
415 Contour of the washout on the workpiece surface
417 Depth of the washout
418 Molten, upwardly spraying material of the workpiece
419 Maximum length of the washout 410 along the workpiece surface
420 Width of the washout along the workpiece surface
421 Slope of the washout towards the edge
423 Molten material spraying out of the workpiece bottom side
430 Contour with which the plasma torch is guided with respect to the workpiece surface
450 Kerf
452 Kerf width
d Plasma torch distance, distance between plasma torch tip and workpiece surface
d1 Plasma torch distance, distance between plasma torch tip and workpiece surface in phase 1
d2 Plasma torch distance, distance between plasma torch tip and workpiece surface in phase 2
d3 Plasma torch distance in phase 3
d4 Plasma torch distance, distance between plasma torch tip and workpiece surface during the cutting in phase 4
d5 Plasma torch distance in phase 5
I1 Current in phase 1
I2 Current in phase 2
I3 Current in phase 3
I4 Current in phase 4 (cutting current)
m Mass flow
m1 Mass flow of plasma gas
m11 Mass flow of plasma gas in phase 1
m12 Mass flow of plasma gas in phase 2
m13 Mass flow of plasma gas in phase 3
m14 Mass flow of plasma gas in phase 4
m2 Mass flow of secondary gas
m21 Mass flow of secondary gas in phase 1
m22 Mass flow of secondary gas in phase 2
m23 Mass flow of secondary gas in phase 3
m24 Mass flow of secondary gas in phase 4
PG Plasma gas
p1 Plasma gas pressure
p11 Plasma gas pressure in phase 1
p12 Plasma gas pressure in phase 2
p13 Plasma gas pressure in phase 3
p14 Plasma gas pressure in phase 4
p2 Secondary gas pressure
p21 Secondary gas pressure in phase 1
p22 Secondary gas pressure in phase 2
p23 Secondary gas pressure in phase 3
p24 Secondary gas pressure in phase 4
SG Secondary gas
v Advancing speed
v1 Advancing speed in phase 1
v2 Advancing speed in phase 2
v3 Advancing speed in phase 3
v4 Advancing speed during the cutting (in phase 4)
v5 Advancing speed in phase 5

1. Method for plasma cutting of workpieces, using at least one plasma cutting torch that comprises one plasma torch body, one electrode, and one nozzle having a nozzle opening through which at least one plasma gas (PG) or plasma gas mixture flows and which constricts a plasma jet, wherein the method comprises:
positioning the plasma cutting torch in relation to a workpiece;
igniting a pilot arc between the electrode and the nozzle of the plasma cutting torch and generating a transmitted plasma arc between the electrode of the plasma cutting torch and the workpiece;
plunge cutting the plasma jet into the workpiece, until the plasma jet is all the way through the workpiece; and
then cutting the workpiece by guiding the plasma cutting torch with an advancing speed v4 at a plasma torch distance d4 from the workpiece with a cutting current I4, so that a kerf with a kerf width is produced, characterized in that, before the plunge cutting of the plasma jet into and through the workpiece, a washout is formed by the workpiece being exposed to the plasma jet from the workpiece surface at least for a duration t2 such that material of the workpiece is removed from the workpiece surface and the washout is produced.

2. The method of claim 1, wherein the method comprises at least the following phases:
Phase 1 with a duration t1, which comprises positioning the plasma cutting torch, igniting the pilot arc and generating the transmitted plasma arc;
Phase 2 with the duration t2, which comprises forming the washout;
Phase 3 with a duration t3, which comprises punch cutting into and through the workpiece; and
Phase 4 with a duration t4, which comprises the cutting.

3. The method of claim 1, wherein, for the duration t2,
the plasma cutting torch is guided with an advancing speed v2 which differs from the advancing speed v4 of the plasma cutting torch during the cutting; and/or
the plasma cutting torch is operated with a current I2 which differs from the cutting current I4 during the cutting; and/or
the plasma cutting torch is positioned at a plasma torch distance d2 which differs from the plasma torch distance d4 during the cutting; and/or
the pressure p12 and/or the volume flow and/or the mass flow m12 of the plasma gas PG or the plasma gas mixture differ(s) from the pressure p14 and/or the volume flow and/or the mass flow m14 of the plasma gas PG during the cutting; and/or
the composition of the plasma gas and/or the plasma gas mixture is a different one than during the cutting.

4. The method of claim 3, wherein, for the duration t2:
the advancing speed v2 of the plasma cutting torch is greater than the advancing speed v4 of the plasma cutting torch during the cutting; and/or
the current I2 is less than the cutting current I4 during the cutting; and/or
the plasma torch distance d2 is greater than the plasma torch distance d4 during the cutting; and/or
the pressure p12 and/or the volume flow and/or the mass flow m12 of the plasma gas PG or the plasma gas mixture are/is less than the pressure p14 and/or the volume flow m14 during the cutting; and/or
the composition of the plasma gas and/or the plasma gas mixture comprises a smaller fraction of oxidizing and/or reducing gas than during the cutting.

5. The method of claim 4, wherein, for the duration t2 or at least some of the duration t2:
the advancing speed v2 of the plasma cutting torch is one of at least one and a half times, at least twice, at least four times, and at least eight times the advancing speed v4 during the cutting; and/or
the current I2 is one of at most 85%, at most 70%, and at most 50% of the cutting current I4 during the cutting; and/or
the plasma torch distance d2 is one of at least 1.5 times, at least twice, and at least 2.5 times the plasma torch distance d4 during the cutting; and/or
the pressure p12 and/or volume flow and/or mass flow m12 of the plasma gas PG or the plasma gas mixture is one of at most 90%, at most 80%, and at most 70% of the pressure p14 and/or the volume flow and/or the mass flow m14 during the cutting; and/or
the composition of the plasma gas and/or the plasma gas mixture comprises a fraction of oxidizing and/or reducing gas that is one of at least 15% by volume, at least 30% by volume, and at least 50% by volume less than the composition of the plasma gas and/or the plasma gas mixture during the cutting.

6. The method of claim 1, wherein the plasma cutting torch additionally has a secondary gas cap which at least partially encloses the nozzle, and a secondary gas (SG) flows between the secondary gas cap and the nozzle.

7. The method of claim 6, wherein, for the duration t2,
the pressure p22 and/or volume flow and/or the mass flow m22 of the secondary gas SG or the secondary gas mixture are/is less than the pressure p24 and/or the volume flow and/or the mass flow m24 of the secondary gas SG or the secondary gas mixture during the cutting; and/or
the secondary gas SG and/or the secondary gas mixture has a different composition than the secondary gas SG and/or the secondary gas mixture during the cutting.

8. The method of claim 7, wherein, for the duration t2,
the pressure p22 and/or volume flow and/or mass flow m22 of the secondary gas SG or the secondary gas mixture is one of at most 90%, at most 80%, and at most 70% of the pressure p24 and/or the volume flow and/or the mass flow m24 of the secondary gas and/or the secondary gas mixture during the cutting; and/or
the composition of the secondary gas and/or the secondary gas mixture comprises a fraction of oxidizing and/or reducing gas that is one of at least 15% by volume, at least 30% by volume, and at least 50% by volume less than the composition of the secondary gas and/or the secondary gas mixture during the cutting.

9. The method of claim 1, wherein, for the duration t2, the advancing speed v2 of the plasma cutting torch and/or the current I2 of the plasma cutting torch and/or the plasma torch distance d2 of the plasma cutting torch and/or the pressure p22 and/or the volume flow and/or the mass flow m22 of the plasma gas PG or the plasma gas mixture and/or the composition of the plasma gas and/or the plasma gas mixture are selected such that between half to all of the molten, upwardly spraying material of the workpiece does not make contact with the plasma cutting torch and/or the plasma torch tip and/or the nozzle and/or the secondary gas cap.

10. The method of claim 1, wherein the washout on the workpiece surface has a length such that the molten material that sprays upwards until the workpiece is punctured through can spray away counter to the cutting direction through the washout such that between half to all of the molten material does not make contact with the plasma cutting torch, the plasma torch tip, the nozzle and/or the secondary gas cap.

11. (canceled)

12. The method of claim 1, wherein the washout has a maximum depth of at least 15% of the workpiece thickness and/or at least 10 mm, measured perpendicularly from the workpiece surface.

13. The method of claim 1, wherein the washout on the workpiece surface has a length of at least 40% of the workpiece thickness and/or at least 20 mm.

14. The method of claim 1, wherein the smallest distance between a contour described by the plasma cutting torch and an edge of the resulting washout is greater than the smallest distance of the contour described by the plasma cutting torch.

15. The method of claim 1, wherein the smallest distance between the contour described by the plasma cutting torch and the edge of the resulting washout is less than or equal to twice the smallest distance of the contour described by the plasma cutting torch.

16. The method of claim 2, wherein, after the formation of the washout and before the cutting, for the duration t3, the plasma cutting torch is positioned such that the plasma jet strikes the edge and/or a slope of the washout at the start of the plunge cutting into and through the workpiece.

17. The method of claim 2, wherein, after the formation of the washout and before the cutting, for the duration t3, an advancing speed v3 for plunge cutting into and through the workpiece is less than the advancing speed v2 during the formation of the washout or 0.

18. The method of claim 17, wherein the advancing speed v3 is one of at most half, at most one quarter, and at most one eighth of the advancing speed v2.

19. The method of claim 2, wherein, after the formation of the washout and before the cutting, for the duration t3, the advancing speed v3 for plunge cutting into and through the workpiece is less than the advancing speed v4 during the cutting or 0.

20. The method of claim 16, wherein a plasma torch distance d3 for plunge cutting for the duration t3 into and through the workpiece is greater than the plasma torch distance d4 during the cutting.

21. The method of claim 15, wherein the plasma torch distance d3 for plunge cutting into and through the workpiece is less than or equal to the plasma torch distance d2 during the formation of the washout.

22. The method of claim 2, wherein, for the duration t1, the plasma torch distance d1 is less than the plasma torch distance d2 for the duration t2 and/or is less than the plasma torch distance d3 for the duration t3 and/or is greater than the plasma torch distance d4 during the cutting.

23. The method of claim 2, wherein, for the duration t1, the advancing speed v1 of the plasma cutting torch is less than the advancing speed v2 for the duration t2 and/or is less than the advancing speed v4 during the cutting.

24. The method of claim 2, wherein, between phase 3 and phase 4, there is at least one further phase in which the plasma torch distance d is less than/the same as the plasma torch distance d3 and greater than the plasma torch distance d4 during the cutting.

25. The method of claim 2, wherein, between phase 3 and phase 4, there is at least one further phase in which the advancing speed v of the plasma cutting torch is greater than the advancing speed v3 and less than the advancing speed v4 during the cutting.

26. The method of claim 2, wherein further phases are present between the phases 1, 2, 3 and 4.

27. The method of claim 26, characterized in that, between phases 1, 2, 3 and 4,
the advancing speed v and/or
the current I and/or
the plasma torch distance d and/or
the pressure p1 and/or the volume flow and/or the mass flow m1 of the plasma gas PG or the plasma gas mixture and/or
the composition of the plasma gas and/or the plasma gas mixture and/or
the pressure p2 and/or volume flow and/or the mass flow m2 of the secondary gas SG and/or
the composition of the secondary gas SG and/or the secondary gas mixture
are/is modified.
